(19) United States
(12) Patent Application Publication
(10) Pub. No.: US 2007/0241551 A1
(43) Pub. Date: Oct. 18, 2007

(54) Automatic Bookmark

(76) Inventor: Jacob C. Graff, Saratoga Springs, UT (US)

Correspondence Address: KIRTON AND MCCONKIE, 60 EAST SOUTH TEMPLE,, SUITE 1800, SALT LAKE CITY, UT, 84111, US

(21) Appl. No.: 11/735,845

(22) Filed: Apr. 16, 2007

Related U.S. Application Data
(60) Provisional application No. 60/792,709, filed on Apr. 18, 2006.

(51) Int. Cl. B42D 9/00

(52) U.S. Cl. 281/42

(57) ABSTRACT

An inexpensive automatic bookmark is provided, wherein the bookmark is made out of a unitary piece of material that is folded and coupled to itself to form the bookmark. The automatic bookmark has a body, a pair of attachment points for attaching to the covers of a book, and a placeholding arm that inserts and removes itself into the marked place in a book when the book is closed and opened, respectively. The bookmark is automatic in that once it is attached to the covers of a book, the bookmark functions to mark and unmark the location in the book by the mere closing and opening of the book.

### CROSS-REFERENCE TO RELATED APPLICATIONS

This application claims the benefit of U.S. Provisional Application No. 60/792,709, filed Apr. 18, 2006, titled AUTOMATIC BOOKMARK, and naming Jacob C. Graff as the inventor.

### BACKGROUND OF THE INVENTION

1. Field of the Invention

The present invention relates to bookmarks, and more particularly to an automatic bookmark and placeholding device.

2. Background and Related Art

Bookmarks have typically provided a method for marking a page in a book. However, most bookmarks are cumbersome to use and easy to lose, as the reader must remember to insert the bookmark before closing the book, and most bookmarks are not attached to the book. Many bookmarks which automatically mark the reader's place in a book are expensive and still cumbersome to use, and can get in the way of the reader easily reading and turning the pages of the book.

### BRIEF SUMMARY OF THE INVENTION

The present invention provides an inexpensive automatic bookmark. The bookmark may be manufactured out of a single piece of cardstock or other suitable material through simple steps of cutting, folding, and gluing. The bookmark may also be inexpensively made out of several pieces of material with additional attachment steps. The bookmark is then affixed to the top of the book, magazine, pamphlet, or other volume to be read and automatically marks the place of the reader without getting in the way of the reader's ability to read or turn the pages of the book.

### BRIEF DESCRIPTION OF THE SEVERAL VIEWS OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIGS. 1-3 show a plan view of an embodiment of the bookmark in its non-folded form.

FIG. 4 shows a perspective view of an embodiment of the bookmark in its folded final form.

FIGS. 5-8 show plan views of alternative embodiments of bookmarks in non-folded form.

### DETAILED DESCRIPTION OF THE INVENTION

Referring now to the figures, a description of a representative embodiment of the present invention will be given. It is expected that the present invention may take many other forms and shapes, hence the following disclosure is intended to be illustrative and not limiting, and the scope of the invention should be determined by reference to the appended claims.

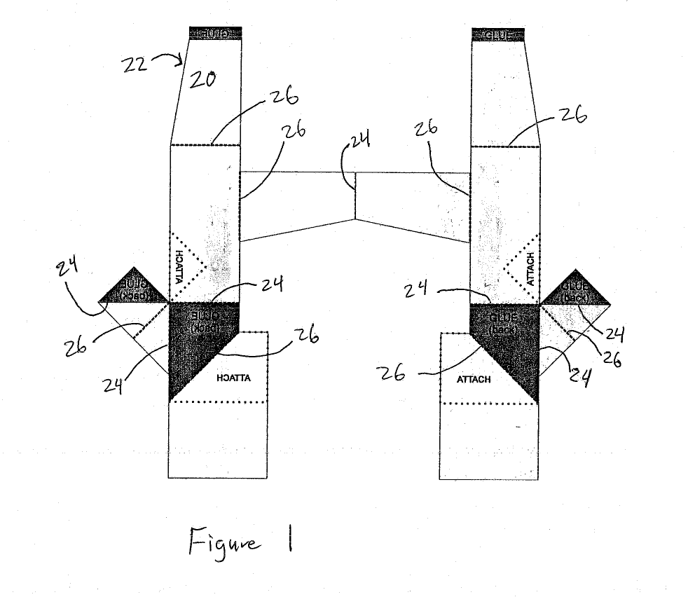

Referring now to FIG. 1 is shown an embodiment of the inventive automatic bookmark in unfolded form. The bookmark of this embodiment may be made of cardstock, paper, plastic, metal, or any other material that is reasonably stiff, substantially planar, and capable of being bent, folded, and attached to itself, as by gluing, stapling, clipping, or taping. In its unfolded form, the embodiment has a top surface 20 and a bottom surface 22 opposite the top surface 20. The bookmark is designed to be cut out from the material from which it is made along the outer perimeter of the bookmark, to leave a single unitary piece in the shape shown in FIG. 1.

Four steps are used to make the embodiment of the bookmark usefully automatic. First, the bookmark should be cut out as described above. Second, the bookmark should be folded, third, certain portions of the bookmark should be attached to other portions of the bookmark, and fourth, certain other portions of the bookmark should be attached to the book or other volume with which the automatic bookmark is to be used. All references herein which refer to use of the bookmark with a book should be interpreted to include use of the bookmark with any suitable volume with pages with which a bookmark may desirably be used. Such volumes include, but are not limited to, magazines, pamphlets, leaflets, tomes, hardbacks, paperbacks, manuscripts, periodicals, journals, binders, folders, and scripts. The final three steps will now be described.

Two types of folds should be made in the bookmark. The first, an inward fold, occurs along inward fold lines 24, such that the fold brings together the top surface 20 of the bookmark on either side of the inward fold line 24 on which the fold is made. The second, an outward fold, occurs along outward fold lines 26, such that the fold brings together the bottom surface 22 of the bookmark on either side of the outward fold line 26 on which the fold is made. In this configuration, a total of seven inward folds and eight outward folds are made, as may be seen in FIG. 1.

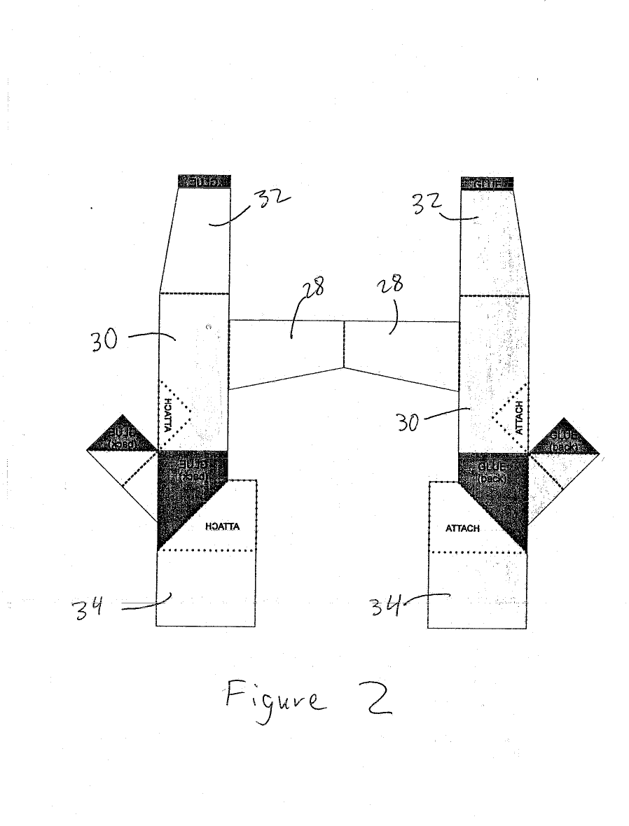

Referring now to FIGS. 2-4, the method of attaching the embodiment of the bookmark to itself to provide automatic functionality will be described. Attachment of the bookmark to itself may be provided in many different ways known in the attachment art, such as gluing, taping, stapling, clipping, riveting, heat welding for materials such as plastic, and any other way known in the art. References to gluing in the following description should be construed as encompassing these other methods as appropriate to the material of the automatic bookmark being used.

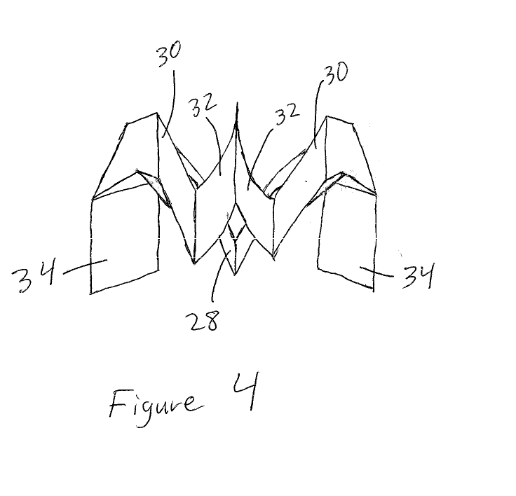

After folding along the fold lines 24, 26 as described above, the embodiment of the automatic bookmark has several main parts, as can be seen in FIG. 2. The bookmark has, in mirror image, a placeholding arm 28, a bookmark body 30, a tension arm 32 and a book attachment tab 34. The bookmark body 30 connects the placeholding arm 28, the tension arm 32 and the book attachment tab 34. FIG. 4 shows, in a perspective view, the relationship of these main parts once the embodiment of the bookmark is in folded form. The long axis of the bookmark body 30 and the tension arms 32 extend in a horizontal direction, while the placeholding arm 28 and the bookmark attachment tabs 34 extend downward from the bookmark body 30 for attachment to or placeholding within a book.

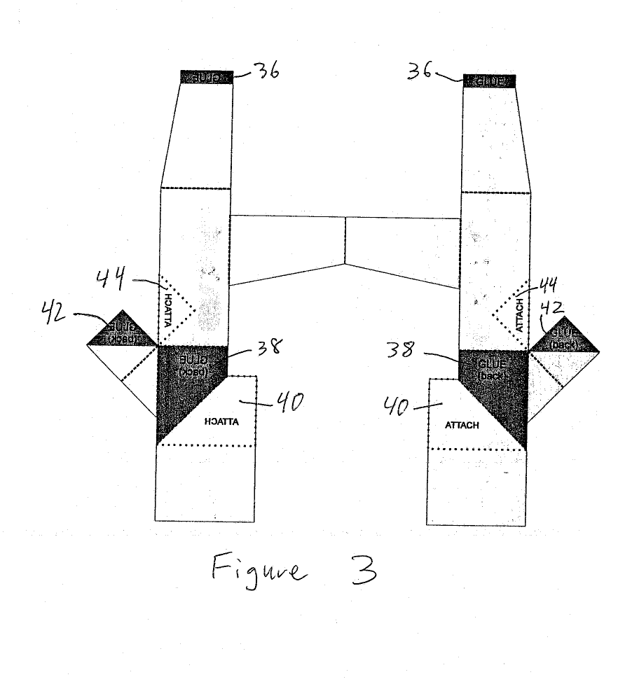

To hold the bookmark in its folded form, the two tension arms 32 are attached to each other by applying glue to the top surface 20 of the tension arms 32 at tension arm tabs 36, as seen in FIG. 3. Once the tension arms 32 are folded so as to be within the folded placeholding arm 28 as in FIG. 4, the top surfaces 20 of the respective tension arm tabs 36 are glued together. This holds in place the relatively orthogonal orientation of the placeholding arm 28 to the bookmark body 30 and tension arms 32.

Next, to fix the orientation of the book attachment tabs 34, glue is affixed to the bottom surface 22 of the bookmark body 30 at attachment point 38 and attachment point 38 is thus glued to attachment point 40 on its bottom surface 22. Finally, glue is affixed to the bottom surface 22 of attachment point 42 and attachment point 42 is thus affixed to the top surface of attachment point 44. In this manner, the embodiment of the bookmark assumes the folded configuration shown in perspective view in FIG. 4.

To use the embodiment of the automatic bookmark, the book attachment tabs 34 are attached to the front and back covers of a book where a bookmark is desirable along either the top or bottom edge of the covers, depending on the location that is most convenient to the reader of the book. Since most readers hold a book at the bottom, the bookmark most normally will be attached at the top of the book. The attachment point relative to the spine of the book is chosen so as to allow proper functioning of the automatic bookmark. This placement is chosen so a proper amount of force is applied to the bookmark by the opening of the book. If the bookmark is placed too close to the spine, the opening of the book will not spread the bookmark sufficiently to cause the placeholding arm 28 to move out of between the book's pages. If the bookmark is placed too far from the spine, the opening of the book will place undue tension on the bookmark and either the reader of the book will be unable to fully open the book, or the tension on the bookmark may cause damage to the bookmark or may cause the bookmark to detach from the book. One of ordinary skill in the art can readily appreciate the proper placement of the bookmark by practicing the invention.

Attachment of the bookmark to the covers of the book can be accomplished by any means known in the art appropriate to the desired permanence of the placement of the bookmark. For example, if the reader desires that the bookmark should be permanently affixed to the book, such as for a book that is repeatedly read or referred to, or such as for a library that desires to attach bookmarks to all its books, the book attachment tabs 34 may be glued, stapled, or taped to the front and back covers of the book. A suitable adhesive or attachment means might be provided during manufacture of the bookmark, so that the reader need merely peel off a backing to expose an adhesive to be attached more or less permanently to the cover of the book.

Alternatively, if permanent attachment is desired upon initial construction of a book, the manufacturer or publisher may incorporate the bookmark as part of the process of adding the cover to the book, and may attach the bookmark to the book cover through an attachment means known in the art of book binding. The current inventive bookmark also encompasses a situation where the bookmark is unitarily manufactured with the cover of the book so that no attachment is necessary between the cover and the bookmark, thus obviating the need for book attachment tabs 34, and the bookmark is then attached to the book through the attachment of the cover to the book. Such a method of attachment might be particularly desirable for a publisher that desires to distinguish itself from other publishers by selling all its books, magazines, or other volumes with attached handy bookmarks.

In contrast, if the reader desires less than permanent affixation of the bookmark to the book, a reversible attachment means may be used to affix the book attachment tabs to the front and back covers of the book, such as using a paper clip, clamp, or other clamping means, or a reversible adhesive, or even a slot provided or permanently affixed to the book that would receive the book attachment tabs 34 to allow easy removal of the bookmark. Such attachment means might be provided and permanently affixed to the bookmark during manufacture of the bookmark. It is also envisioned that the book attachment tabs 34 might be extended in length to provide more secure attachment to the book, especially when a reversible attachment means is used to affix the bookmark to the book. Furthermore, the bookmark itself might be permanently attached to a reversible attachment means, such as a clip, clamp, etc. which would then be reversibly attached to the book.

It is further envisioned that in some situations, such as for very thick books or where a reader desires a bookmark in two locations to make referring back and forth simple, multiple bookmarks in the same book might be desirable. In such a case, one or both book attachment tabs 34 might be attached to a piece of cardstock or other suitable book attachment tab extension, such as metal or plastic, inserted into the book or even be attached to one of the pages of the book instead of to one of the covers of the book. In this manner, two or even more automatic bookmarks could be provided in the same book. Also in this manner, one or more book attachment tabs 34 or extensions thereof might also serve as a secondary, less-movable bookmark or placeholder at the point or points where book attachment tabs 34 or extensions thereof are placed within a book not at the cover of the book.

In use, the book attachment tabs 34 are attached to the book as described above, so that the lower edge of the bookmark body 30 rests slightly above the tops of the pages of the book and the lower edge of the bookmark body 30 is substantially parallel to the top edges of the pages of the book. When the book is closed, the placeholding arm 28 extends downwardly from the lower edge of the bookmark body 30 so as to extend beyond the top edge of the pages of the book, thus marking a place within the book. When the book is opened, opening force is transferred from the book attachment tabs 34 through the bookmark body 30 to the tension arms 32 and the placeholding arm 28. This force and opening motion forces the two sides or pieces of the bookmark body 30 nearer the spine of the book apart, and since the placeholding arm 28 is attached to the bookmark body 30, it also spreads apart. This spreading action raises the placeholding arm 28 so that it no longer interposes between the pages of the book, allowing the pages of the book to be freely turned while the book is open. The tension arms 32 help hold the bookmark in the proper position to allow the opening force of the book to be translated into an upward force and movement on the placeholding arm 28.

As the book is closed, the reverse occurs, and the placeholding arm 28 again descends to a position between the pages of the book. However, the placeholding arm 28 descends to the point in the book that is now open, thus holding the current place in the book of the reader, and functioning as an automatic bookmark. Thus the reader does not have to think about placing the bookmark in an appropriate place in the book. When the reader is finished reading, he or she need merely close the book and the automatic bookmark will automatically insert the placeholding arm at the point in the book where the reader was reading when he or she closed the book. In addition, if the book is inadvertently dropped during reading, the automatic bookmark will often function to interpose itself in the place where the book was last open, thus saving the place of the reader and preventing unnecessary searching to recover the reader's place in the book.

Thus the present invention provides an inexpensive and novel automatic bookmark that is simple to manufacture and use and effective at marking one's place in a book.

It is envisioned that the bookmark may be manufactured in other forms without departing from the spirit and essential characteristics of the invention. For example, in another embodiment, the major pieces of the bookmark may be made from individual pieces of material, such as metal, and instead of providing folds at fold lines 24, 26 as described above, the individual pieces are connected together at hinges providing the same functionality. For example, a more expensive and exclusive model might be provided and manufactured from metal, decorative plastic, or some other material, and the hinges might be of metal or fabric to provide an interesting look while maintaining the functionality of the bookmark. Furthermore, in other embodiments the actual shape of the bookmark depicted in the figures may vary and still maintain the functionality of the bookmark as described and claimed.

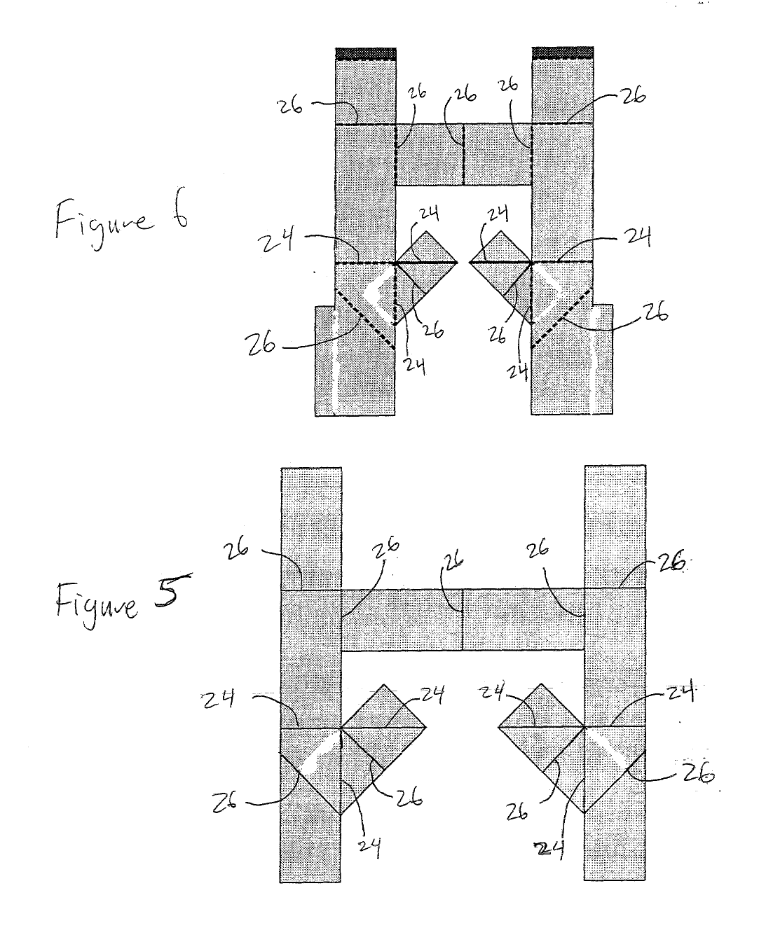

For example, other illustrative embodiments and shapes are portrayed in FIGS. 5-8 in unfolded form. In FIGS. 5-7, the method of attachment of the various portions of the bookmark to itself and functionality of the bookmark is similar, and the method of folding the embodiments is primarily shown so as to maintain the inventive functionality. Referring to FIGS. 5 and 6, two illustrative embodiments are shown showing the inward fold lines 24 and outward fold lines 26. The self-attachment and functionality of the bookmark remains the same, but upon folding the bookmark, the user will see that in the folded form the placeholding arm 28 extends from the lower edge of the bookmark body 30 whereas in the first embodiment illustrated in FIGS. 1-4, the placeholding arm 28 extends from the upper edge of the bookmark body 30 (see FIG. 4).

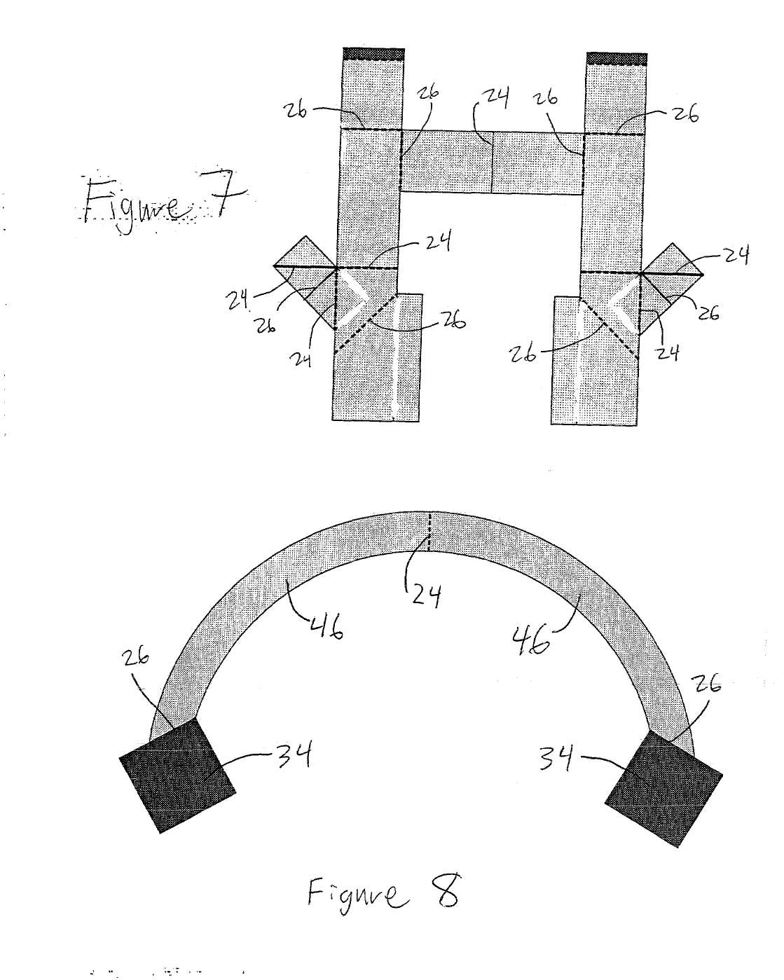

FIG. 7 shows an embodiment similar to the embodiment of FIGS. 1-4, wherein the placeholding arm 28, when in the folded state, extends from the upper edge of the bookmark body 30, as in FIG. 4. Thus these Figures illustrate how the shape of the bookmark may be varied without departing from its essential characteristics.

FIG. 8 shows an embodiment wherein the bookmark body 30 and placeholding arm 28 are combined in a unitary bookmark body and placeholding arm 46. This Figure shows a total of three folds: one inward fold upon inward fold line 24, and two outward folds upon outward fold lines 26. In folded form, the bookmark has only two main parts. The unitary bookmark body and placeholding arm 46, and a pair of book attachment tabs 34. In use, this embodiment of the bookmark attaches to the book as described for the previous embodiments, and as the book is opened or closed the unitary bookmark body and placeholding arm 46 swing together in one simple motion to alternatively mark the location in the book or allow turning of the pages of the opened book. In this embodiment, the unitary bookmark body and placeholding arm 46 may be designed to be flexible so that if a portion of the unitary bookmark body and placeholding arm 46 remains in the path of a page to be turned when the book is open, the unitary bookmark body and placeholding arm are easily displaced by a very slight pressure of the turning page, thus not obstructing the turning of the pages.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed and desired to be secured by Letters Patent is:

1. An automatic bookmark comprising:
a body;
a pair of book attachment portions attached to the body; and
a placeholding arm attached to the body, wherein the body, the book attachment portions, the arm, and the connections therebetween are configured so that when the book attachment portions are attached to a book, an opening force applied to the book is translated through the book attachment portions and the body into a lifting force on the arm.

2. The bookmark of claim 0 wherein the bookmark is comprised of a unitary piece of material folded and configured to comprise the body, the book attachment portions, and the arm.

3. The bookmark of claim 0 wherein the bookmark is comprised of a plurality of pieces of material connected by hinges.

4. The bookmark of claim 0 further comprising:
a book wherein each of the book attachment portions is attached to at least one of a cover of the book, a page of the book, or an insert inserted into the book.

5. The bookmark of claim 1 wherein the bookmark is made out of cardstock.

6. The bookmark of claim 0 wherein the bookmark is made out of paper.

7. The bookmark of claim 1 wherein the bookmark is made out of plastic.

8. An automatic bookmark made by folding and coupling parts of one unitary piece of material comprising:
a unitary piece of material cut, folded, and coupled to form:
a body;
a pair of book attachment portions attached to the body; and
a placeholding arm attached to the body, wherein the body, the book attachment portions, the arm, and the connections therebetween are configured so that when the book attachment portions are attached to a book, an opening force applied to the book is translated through the book attachment portions and the body into a lifting force on the arm.

9. The bookmark of claim 8 further comprising a book wherein each of the book attachment portions is attached to at least one of a cover of the book, a page of the book, or an insert inserted into the book.

10. The bookmark of claim 8 wherein the bookmark is made out of cardstock.

11. The bookmark of claim 8 wherein the bookmark is made out of paper.

12. The bookmark of claim 8 wherein the bookmark is made out of plastic.
